(19) United States
(12) Patent Application Publication
(10) Pub. No.: US 2010/0123395 A1
(43) Pub. Date: May 20, 2010

(54) HEADLAMP CONTROL DEVICE FOR VEHICLE

(76) Inventors: Hyun Chang AHN, Uiwang-si (KR); Woo Yong KIM, Uiwang-si (KR)

Correspondence Address: IPLA P.A., 3550 WILSHIRE BLVD., 17TH FLOOR, LOS ANGELES, CA, 90010, US

(21) Appl. No.: 12/580,003

(22) Filed: Oct. 15, 2009

(30) Foreign Application Priority Data
Nov. 20, 2008 (KR) 10-2008-0115652

(51) Int. Cl. B60Q 1/02; G01J 3/10; G01S 13/00

(52) U.S. Cl. 315/82; 250/504 R; 342/59

(57) ABSTRACT

A headlamp control device for a vehicle is provided. The device includes a front sensor, a wheel speed sensor, an Electrical Control Unit (ECU), a first ballaster, a second ballaster, a relay switch, and a power supply switch. The front sensor senses a target vehicle. The wheel speed sensor detects a speed of a reference vehicle. The ECU outputs a switching control signal. The first ballaster generates a first boosting voltage. The second ballaster generates a second boosting voltage. The relay switch supplies an internal voltage to first and second high-beam lamps, or first and second ballasters. The power supply switch turns on in response to a switching control signal.

### CROSS REFERENCE

This application claims foreign priority under Paris Convention and 35 U.S.C. §119 to each of Korean Patent Application No. 10-2008-0105652, filed 20 Nov. 2008 with the Korean Intellectual Property Office.

### BACKGROUND OF THE INVENTION

1. Field of the Invention

The present invention relates to a headlamp for a vehicle, and more particularly, to a headlamp control device for a vehicle.

2. Description of the Related Art

A lamp of a bulb type has been mainly used as a headlamp for a vehicle however, in recent years, a High Intensity Discharge (HID) lamp has been also widely used as a headlamp for a vehicle. The headlamp can be set for high beams or low beams depending on an irradiation angle of light.

If the headlamp is set for high beams, driver's sight is secured up to a relatively far distance from the front of a vehicle and thus, a driver can safely travel even at night. However, it can give eye dazzling to a driver of a vehicle coming from the other side or a driver of a vehicle of the front. Also, if the headlamp is set for low beams, eye dazzling of the driver of the vehicle coming from the other side or the driver of the vehicle of the front can be reduced. However, compared to the high beams, the low beams are vulnerable to security of driver's sight.

In the conventional headlamp, a driver has to manually manipulate a switch of a headlamp to set the headlamp for high beams or low beams. Thus, when a vehicle approaches from the other side, if the headlamp is not set for the low beams due to driver's carelessness, it gives eye dazzling to a vehicle driver of the other side, thus causing the danger of generation of a traffic accident. Also, because the driver has to manipulate the switch of the headlamp during driving, this manipulation is very trouble to the driver.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide a headlamp control device for a vehicle, for preventing a traffic accident and providing a driver with a convenience, by sensing if a vehicle exists within a set range of the front using a front sensor such as a RAdio Detecting And Ranging (RADAR) sensor, a ridar sensor, or a camera and automatically setting a headlamp for high beams or low beams depending on the sense result.

To achieve these and other advantages and in accordance with the purpose of the present invention, there is provided a headlamp control device for a vehicle. The device includes a front sensor, a wheel speed sensor, an Electrical Control Unit (ECU), a first ballaster, a second ballaster, a relay switch, and a power supply switch. The front sensor senses a target vehicle existing within a set area of the front of a reference vehicle, and outputs a sense signal. The wheel speed sensor is installed in a wheel of the reference vehicle, and detects a speed of the reference vehicle on the basis of a rotatory speed of the wheel. The ECU outputs a switching control signal in response to a lighting signal. While first and second high-beam lamps light on, the ECU calculates a relative speed of the target vehicle, a distance between the reference vehicle and the target vehicle, and an angle for a position of the target vehicle based on a moving direction of the reference vehicle, on the basis of the speed of the reference vehicle received from the wheel speed sensor and the sense signal received from the front sensor. On the basis of the calculation result, the ECU outputs a control current. The first ballaster generates a first boosting voltage on the basis of an internal voltage, and supplies the first booting voltage as an operation power source to a first High Intensity Discharge (HID) lamp. The second ballaster generates a second boosting voltage on the basis of the internal voltage, and supplies the second boosting voltage as an operation power source to a second HID lamp. When the internal voltage is applied, the relay switch supplies the internal voltage to the first and second high-beam lamps. While the control current is supplied by the ECU, the relay switch stops supplying the internal voltage to the first and second high-beam lamps and then, supplies the internal voltage to the first and second ballasters. The power supply switch turns on in response to the switching control signal, and applies the internal voltage to the relay switch.

As described above, the headlamp control device for the vehicle according to the present invention senses if a vehicle exists within a set range of the front using a front sensor such as a radar sensor, a ridar sensor, or a camera and, depending on the sense result, automatically sets a headlamp for high beams or low beams, thus being able to prevent a traffic accident and provide a convenience to a driver.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic block diagram illustrating a construction of a headlamp control device for a vehicle according to an exemplary embodiment of the present invention;

FIG. 2 is a plan diagram illustrating a vehicle in which a front sensor illustrated in FIG. 1 is installed;

FIG. 3 is a schematic diagram illustrating an example of a front sensor illustrated in FIG. 1;

FIG. 4 is a schematic diagram illustrating another example of a front sensor illustrated in FIG. 1;

FIG. 5 is a conceptual diagram for describing operation of a front sensor and an Electrical Control Unit (ECU) illustrated in FIG. 1;

FIG. 6 is a schematic block diagram illustrating a construction of a headlamp control device for a vehicle according to another exemplary embodiment of the present invention;

FIG. 7 is a conceptual diagram for describing operation of a front sensor and an ECU illustrated in FIG. 6; and

FIGS. 8 and 9 are diagrams illustrating more details of parts of the conceptual diagram illustrated in FIG. 7.

Throughout the drawings, the same drawing reference numerals will be understood to refer to the same elements, features and structures.

### DETAILED DESCRIPTION OF THE INVENTION

Exemplary embodiments of the present invention will now be described in detail with reference to the annexed drawings. In the following description, a detailed description of known functions and configurations incorporated herein has been omitted for conciseness.

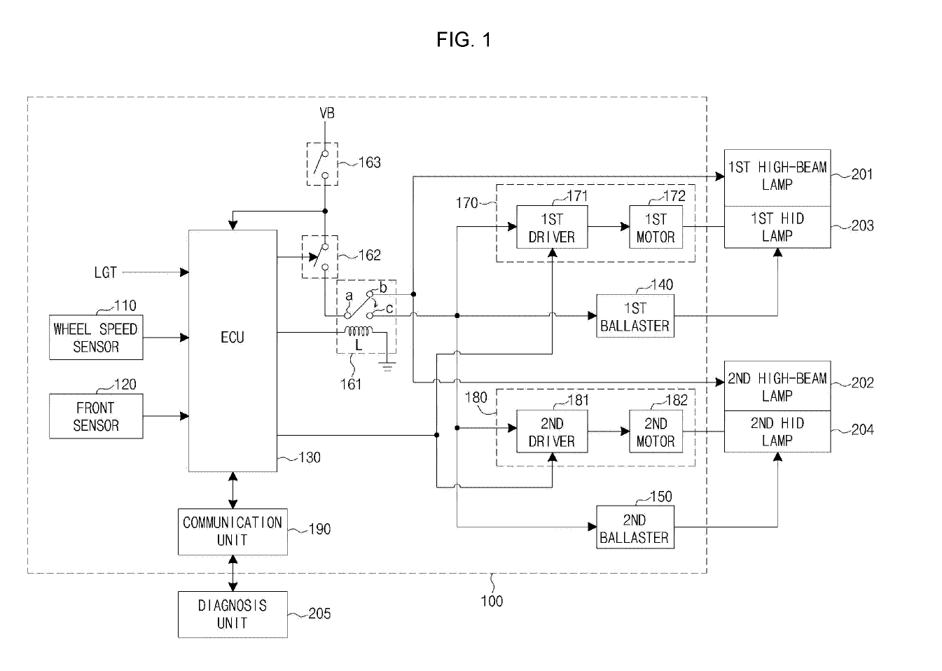

FIG. 1 is a schematic block diagram illustrating a construction of a headlamp control device for a vehicle according to an exemplary embodiment of the present invention. For the simplification of the drawings, FIG. 1 illustrates only portions related to the present invention, and omits illustration of transmit/receive signals between respective constituent elements. Also, for a description convenience, a vehicle having a headlamp control device 100 for a vehicle installed is called a reference vehicle, and a vehicle moving into a set area of the front of the reference vehicle is called a target vehicle.

The headlamp control device 100 for the vehicle includes a wheel speed sensor 110, a front sensor 120, an Electrical Control Unit (ECU) 130, first and second ballasters 140 and 150, a relay switch 161, a power supply switch 162, a lighting switch 163, first and second leveling units 170 and 180, and a communication unit 190. The first leveling unit 170 includes a first driver 171 and a first motor 172. The second leveling unit 180 includes a second driver 181 and a second motor 182.

The wheel speed sensor 110 is installed in a wheel of a reference vehicle, and detects a speed of the reference vehicle on the basis of a speed of revolution of the wheel. The front sensor 120 senses a target vehicle existing within a set area of the front of the reference vehicle, and outputs a sense signal (SEN) to the ECU 130. The ECU 130 outputs a switching control signal (SWCTL) to the power supply switch 162 in response to a lighting signal (LGT). When a user powers on a headlamp through an input unit (not shown), the lighting signal (LGT) is input to the ECU 130.

While first and second high-beam lamps 201 and 202 light on, the ECU 130 receives a speed (SPD) of the reference vehicle from the wheel speed sensor 110, and receives a sense signal (SEN) from the front sensor 120. The ECU 130 calculates a relative speed of the target vehicle, a distance between the reference vehicle and the target vehicle, and an angle for a position of the target vehicle based on a moving direction of the reference vehicle, on the basis of peed of the reference vehicle and the sense signal (SEN). The ECU 130 outputs a control current (Ic) to the relay switch 161 on the basis of the calculation result. The ECU 130 can accurately recognize a time to change the headlamp from high beams to low beams on the basis of the relative speed of the target vehicle.

When a distance (R1 or R2) between a reference vehicle (‘B’ in FIG. 5) and a target vehicle (‘A’ or ‘C’ in FIG. 5) is included within a set distance range, and an angle for a position of a target vehicle based on a moving direction of the reference vehicle is included within a set angle range, the ECU 130 outputs a control current (Ic) to the relay switch 161. Also, when the distance between the reference vehicle and the target vehicle is out of the set distance range, or the angle for the position of the target vehicle based on the moving direction of the reference vehicle is out of the set angle range, the ECU 130 stops supplying the control current (Ic). The set angle range can be set up to 120° at each of a left side (θ1 in FIG. 5) and right side (θ2) of the moving direction (D1 in FIG. 5) of the reference vehicle, on the basis of the moving direction (D1) of the reference vehicle.

The first ballaster 140 generates a first boosting voltage (VBST1) on the basis of an internal voltage (VB), and supplies the first boosting voltage (VBST1) to a first High Intensity Discharge (HID) lamp 203 as an operation power source. The second ballaster 150 generates a second boosting voltage (VBST2) on the basis of the internal voltage (VB), and supplies the second boosting voltage (VBST2) to a second HID lamp 204 as an operation power source.

FIG. 1 illustrates an example of a case in which the first and second high-beam lamps 201 and 202 and the first and second HID lamps 203 and 204 are used as headlamps of a vehicle. The first high-beam lamp 201 and the first HID lamp 203 can be installed at a left side of the vehicle front, and the second high-beam lamp 202 and the second HID lamp 204 can be installed at a right side of the vehicle front. Also, when the headlamps of the vehicle are set for high beams, the first and second high-beam lamps 201 and 202 light on and, when the headlamps of the vehicle are set for low beams, the first and second HID lamps 203 and 204 light on.

When the internal voltage (VB) is applied, the relay switch 161 supplies the internal voltage (VB) to the first and second high-beam lamps 201 and 202. While the control current (Ic) is supplied by the ECU 130, the relay switch 161 stops supplying the internal voltage (VB) to the first and second high-beam lamps 201 and 202 and then, supplies the internal voltage (VB) to the first and second ballasters 140 and 150.

A construction of the relay switch 161 is described in more detail. A contact point (a) of the relay switch 161 connects to one side terminal of the power supply switch 162. The first and second high-beam lamps 201 and 202 connect to a contact point (b) of the relay switch 161. The first and second drivers 171 and 181 and the first and second ballasters 140 and 150 connect to a contact point (c) of the relay switch 161.

When the control current (Ic) flows in a coil (L) of the relay switch 161, the contact point (a) of the relay switch 161 connects to the contact point (c). When the control current (Ic) does not flow in the coil (L), the contact point (a) of the relay switch 161 connects to the contact point (b).

The power supply switch 162 turns on in response to a switching control signal (SWCTL) received from the ECU 130. When the power supply switch 162 turns on, the internal voltage (VB) is applied to the relay switch 161.

The internal voltage (VB) is input to one side terminal of the lighting switch 163, and the other side terminal of the lighting switch 163 connects to a terminal of the power supply switch 162. When a lighting key (not shown) of a vehicle is ON, the lighting switch 163 turns on, thus supplying the internal voltage (VB) to the ECU 130 and the power supply switch 162.

When the lighting switch 163 and the power supply switch 162 all turn on, the internal voltage (VB) is supplied to the first and second high-beam lamps 201 and 202. Also, when the lighting switch 163 and the power supply switch 162 all turn on and the contact point (a) of the relay switch 161 connects to the contact point (c), the internal voltage (VB) is supplied to the first and second drivers 171 and 181 and the first and second ballasters 140 and 150.

The first driver 171 controls an operation of the first motor 172 on the basis of a leveling control signal (LCTL) received from the ECU 130. The second driver 181 controls an operation of the second motor 182 on the basis of the leveling control signal (LCTL). The first motor 172 changes an irradiation angle of the first HID lamp 203 by moving a housing (not shown) of the first HID lamp 203 or a reflection plate (not shown) installed within the housing of the first HID lamp 203.

The second motor 182 changes an irradiation angle of the second HID lamp 204 by moving a housing (not shown) of the second HID lamp 204 or a reflection plate (not shown) installed within the housing of the second HID lamp 204.

The communication unit 190 provides communication between an external diagnosis unit 205 and the ECU 130. The diagnosis unit 205 diagnoses the normality or abnormality of each constituent element of the headlamp control device 100 through communication with the ECU 130.

Meantime, the front sensor 120 can be realized by a radar sensor or a ridar sensor.

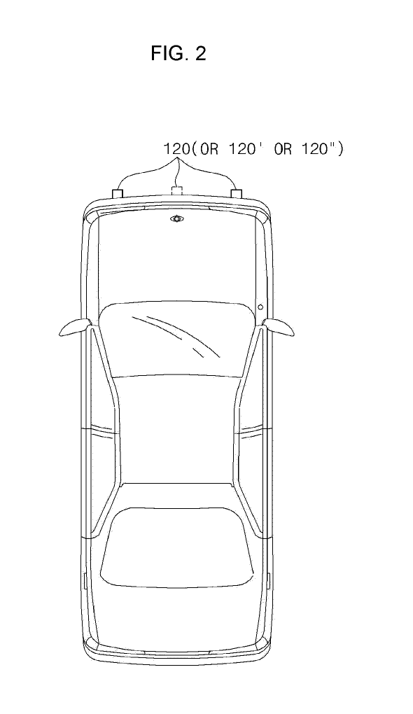

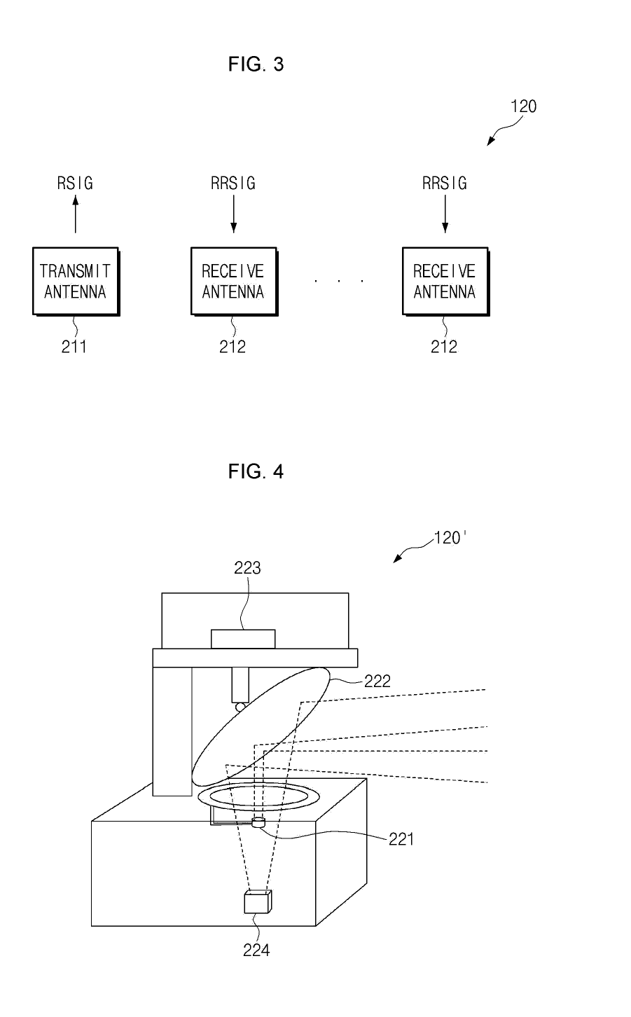

A case of realizing the front sensor 120 as the radar sensor 120 is described with reference to FIG. 3. As illustrated in FIG. 2, the radar sensor 120 can be installed one (a dotted-line portion) or two (a dashed-line portion) in a front part of the reference vehicle. The radar sensor 120 includes a transmit antenna 211 and a plurality of receive antennas 212. The transmit antenna 211 transmits a radar signal (RSIG) within a set area of the front of the reference vehicle (‘B’ in FIG. 5) at a set time interval. The plurality of receive antennas 212 receive a reflection radar signal (RRSIG) that is a reflection and return of the radar signal (RSIG) transmitted by the transmit antenna 211 from the target vehicle (‘A’ or ‘C’ in FIG. 5). The plurality of receive antennas 212 output the reflection radar signal (RRSIG) as a sense signal (SEN), to the ECU 130.

A process of calculating, by the ECU 130, a relative speed of a target vehicle, a distance between a reference vehicle and the target vehicle, and an angle for a position of the target vehicle based on a moving direction of the reference vehicle, on the basis of a reflection radar signal (RRSIG) and a speed (SPD) of the reference vehicle can be well understood by those skilled in the art and thus, its detailed description is omitted.

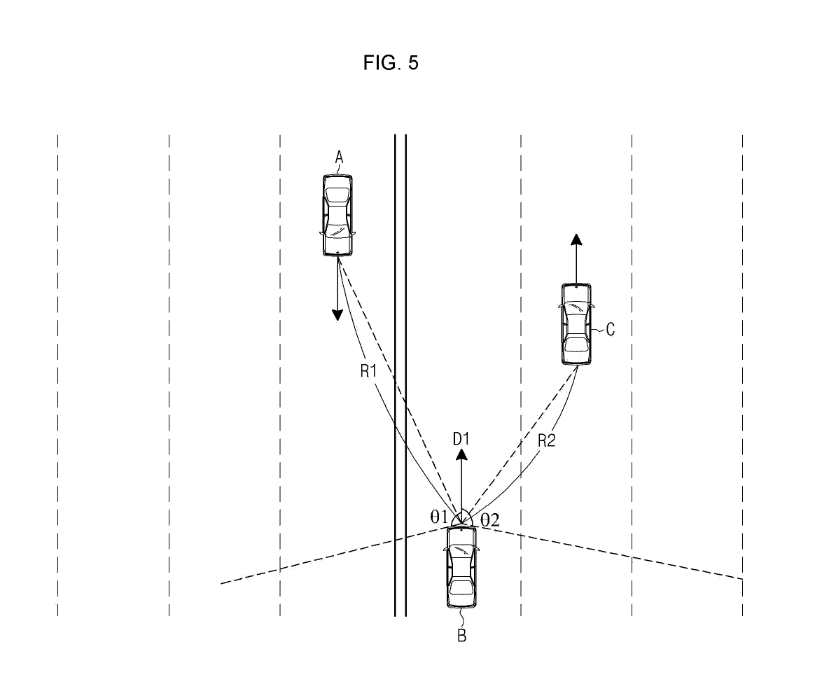

Referring to FIG. 4, a ridar sensor 120′ is illustrated as another example of the front sensor 120. As illustrated in FIG. 2, the ridar sensor 120′ can be installed one or two in a front part of the reference vehicle. The ridar sensor 120′ includes an infrared transmit diode 221, a rotatory mirror 222, and a photo diode receiver 224. The infrared transmit diode 221 generates an infrared signal (IRSIG).

The rotatory mirror 222 is rotated at a set speed by a motor 223 and controls a transmit direction of the infrared signal (IRSIG) such that the infrared signal (IRSIG) scans a set area of the front of the reference vehicle (‘B’ in FIG. 5). The photo diode receiver 224 receives a reflection infrared signal (RIRSIG) that is a reflection and return of the infrared signal (IRSIG) from the target vehicle (‘A’ or ‘C’ in FIG. 5). The photo diode receiver 224 outputs the reflection infrared signal (RIRSIG) as a sense signal (SEN), to the ECU 130.

A process of calculating, by the ECU 130, a relative speed of a target vehicle, a distance between a reference vehicle and the target vehicle, and an angle for a position of the target vehicle based on a moving direction of the reference vehicle, on the basis of a reflection infrared signal (RIRSIG) and a speed (SPD) of the reference vehicle can be well understood by those skilled in the art and thus, its detailed description is omitted.

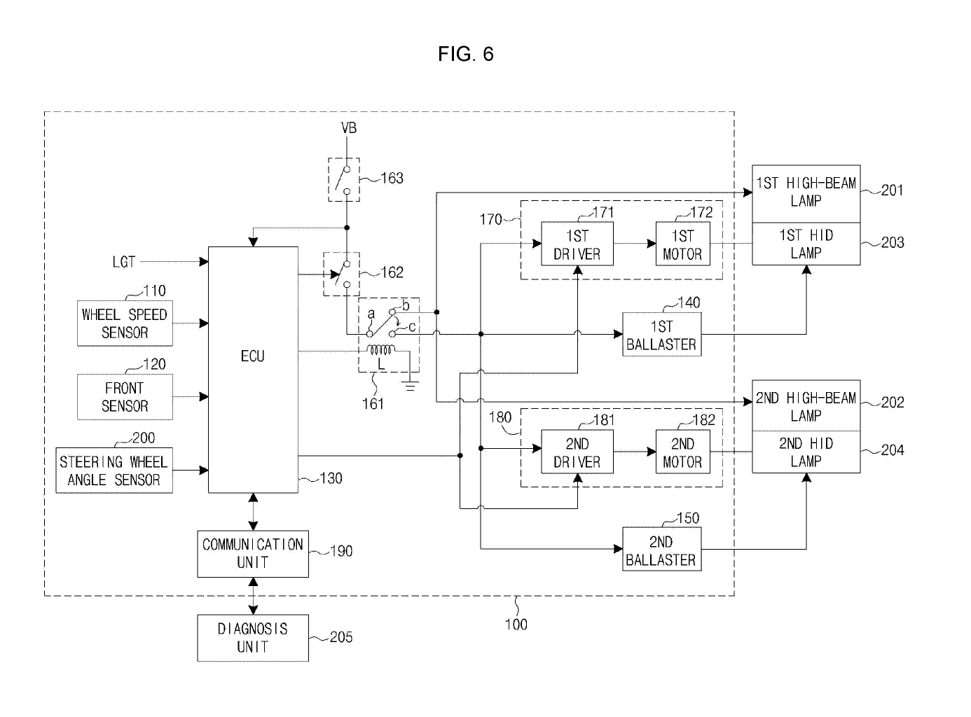

FIG. 6 is a schematic block diagram illustrating a construction of a headlamp control device for a vehicle according to another exemplary embodiment of the present invention. A construction and detailed operation of the headlamp control device 101 for the vehicle substantially are the same as a construction and operation of the headlamp control device 100 for the vehicle described with reference to FIG. 1, excepting one difference. Thus, in the present exemplary embodiment, to avoid repeating a description, a description is made centering on the difference between the headlamp control devices 101 and 100 for the vehicle.

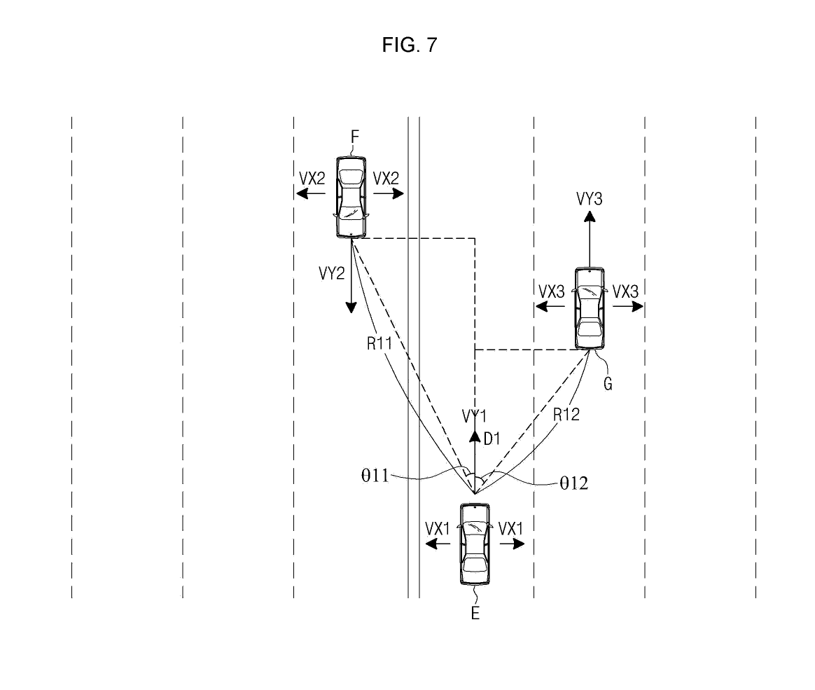

A difference between the headlamp control devices 101 and 100 for the vehicle is that the headlamp control device 101 for the vehicle includes a steering wheel angle sensor 200, and the front sensor 120 is realized as the camera 120″. The steering wheel angle sensor 200 detects a rotatory angle (CLAG) of a steering wheel of the reference vehicle and outputs the detected rotatory angle (CLAG) to the ECU 130. As illustrated in FIG. 2, the camera 120″ can be installed one or two in a front part of the reference vehicle. The camera 120″ takes a photograph of a set area of the front of a reference vehicle (‘E’ in FIG. 7), and outputs a photograph data signal (PDAT) to the ECU 130.

While the first and second high-beam lamps 201 and 202 light on, the ECU 130 calculates a relative speed of a target vehicle (‘F’ or ‘G’ in FIG. 7), a distance between the reference vehicle and the target vehicle, and an angle (θ11 or θ12) for a position of the target vehicle (‘F’ or ‘G’) based on a moving direction (D1) of the reference vehicle (E), on the basis of a speed (SPD) of the reference vehicle received from the wheel speed sensor 110, a rotatory angle (CLAG) of a steering wheel received from the steering wheel angle sensor 200, and a photograph data signal (PDAT) received from one or two cameras 120″.

This is described in more detail. The ECU 130 obtains a direction of a vector dependent on the moving direction of the reference vehicle on the basis of the rotatory angle (CLAG) of the steering wheel, and calculates a magnitude of the vector on the basis of the speed (SPD) of the reference vehicle.

The ECU 130 converts a color video expressed by the photograph data signal (PDAT) into a black-and-white video whose specific color component (e.g., a lane and a vehicle) is highlighted. After that, the ECU 130 filters the black-and-white video and extracts only a lane and vehicle portion. At this time, in the extracted video, an image of a vehicle is displayed bigger compared to an image of a lane.

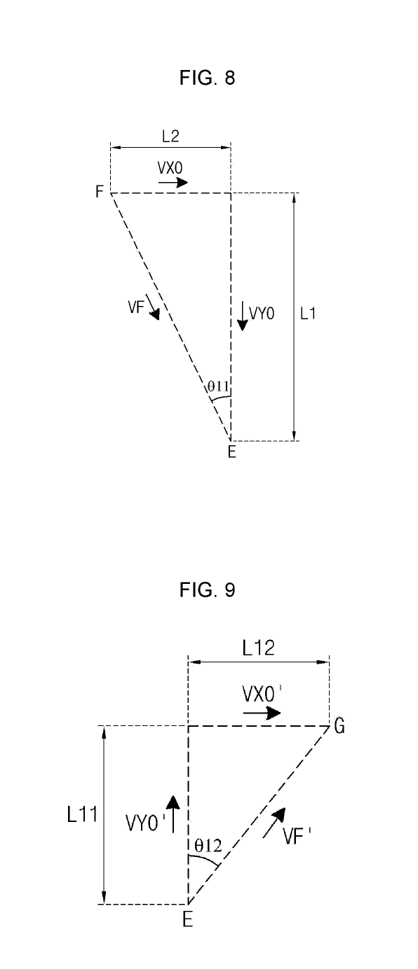

For example, a process of, when a target vehicle is the target vehicle (F) moving oppositely to the moving direction of the reference vehicle (E), calculating, by the ECU 130, a relative speed of the target vehicle (F), a distance between the reference vehicle (E) and the target vehicle (F), and an angle (θ11) for a position of the target vehicle (F) based on a moving direction (D1) of the reference vehicle (E) is described with reference to FIG. 8.

The ECU 130 calculates a distance (R11 in FIG. 7) between the reference vehicle (E) and the target vehicle (F) on the basis of a set distance per pixel, in a video in which only a lane and vehicle portion is extracted by filtering. For example, when one meter is set per pixel and there are 20 pixels between the reference vehicle (E) and the target vehicle (F), the distance between the reference vehicle (E) and the target vehicle (F) is calculated as 20 meters.

Meantime, the ECU 130 calculates a relative speed (VF in FIG. 8) of the target vehicle (F) on the basis of Equation 1 below.

VF=\sqrt{VX0²+VY0²} (1)

The ECU 130 can calculate speeds (VX1 and VX2 in FIG. 7) of horizontal directions of the vehicles (E and F) and a speed (VY2 in FIG. 7) of a moving direction of the target vehicle (F) from a plurality of frames of the video in which only the lane and vehicle portion is extracted by filtering. The ECU 130 can recognize a change of a pixel (i.e., number of pixels of movement of the vehicles (E and F)) during a set time from the plurality of frames.

For example, if photograph is taken from a first frame to a third frame during three seconds, and the vehicle (E) moves from a position at the first frame to a position at the third frame in a horizontal direction as much as three pixels, when a distance per pixel is equal to one meter, the speed (VX1) is 1 m/sec. Similarly with this, the speeds (VX2 and VY2) can be also calculated. Meantime, the ECU 130 obtains a direction of a vector (i.e., a speed (VY1)) dependent on the moving direction of the reference vehicle, on the basis of a rotatory angle (CLAG) of a steering wheel, and calculates a magnitude of the vector on the basis of a speed (SPD) of the reference vehicle.

The ECU 130 can calculate speeds (VX0 and VY0), on the basis of the speeds (VX1, VX2, VY1, and VY2) obtained by the aforementioned calculation process and Equation 2 below.

VX0=VX2−VX1,

VY0=VY2−(−VY1) (2)

In Equation 2, a negative sign (−) is affixed before ‘VY1’ because the moving direction of the target vehicle (F) and the moving direction of the reference vehicle (E) are opposite to each other. The ECU 130 can calculate the relative speed (VF) of the target vehicle (F), on the basis of Equation 1 and Equation 2.

Next, the angle (θ11) for the position of the target vehicle (F) based on the moving direction (D1) of the reference vehicle (E) can be calculated in two methods. The first method is a calculation method using the speeds (VX0 and VY0). The second method is a calculation method using distances (L1 and L2 in FIG. 8). The distances (L1 and L2) can be calculated on the basis of a set distance per pixel.

The angle (θ11) can be expressed using the speeds (VX0 and VY0) as in Equation 3 below.

$$θ 11 = {tan}^{- 1} \frac{V X 0}{V Y 0} \qquad ( 3 )$$

Also, the angle (θ11) can be expressed using the distances (L1 and L2) as in Equation 4 below.

$$θ 11 = {tan}^{- 1} \frac{L 2}{L 1} \qquad ( 4 )$$

For example, a process of, when a target vehicle is the target vehicle (G) moving identically with a moving direction of the reference vehicle (E), calculating, by the ECU (130), a relative speed of the target vehicle (G), a distance between the reference vehicle (E) and the target vehicle (G), and an angle (θ12) for a position of the target vehicle (G) based on the moving direction (D1) of the reference vehicle (E) is described with reference to FIG. 9.

The ECU 130 calculates a distance (R12 in FIG. 7) between the reference vehicle (E) and the target vehicle (G) on the basis of a set distance per pixel, in a video in which only a lane and vehicle portion is extracted by filtering.

Meantime, the ECU 130 calculates a relative speed (VF′ in FIG. 9) of the target vehicle (G) on the basis of Equation 5 below.

VF′=\sqrt{VX0′²+VY0′²} (5)

The ECU 130 can calculate speeds (VX1 and VX3 in FIG. 7) of horizontal directions of the vehicles (E and G) and a speed (VY3 in FIG. 7) of a moving direction of the target vehicle (G) from a plurality of frames of the video in which only the lane and vehicle portion is extracted by filtering. Similarly with the aforementioned, the ECU 130 can recognize a change of a pixel (i.e., number of pixels of movement of the vehicles (E and G)) from a plurality of frames photographed during a set time and, calculate the speeds (VX1, VX3, and VY3) on the basis of a distance dependent on the pixel change and a photograph time.

The ECU 130 can calculate speeds (VX0′ and VY0′) on the basis of the speeds (VX1, VX3, VY1, and VY3) obtained in the aforementioned calculation process and Equation 6 below.

VX0′=VX2−VX1,

VY0′=VY2−VY1 (6)

In Equation 6, in contrast to Equation 2, a negative sign (−) is not affixed before ‘VY1’ because the moving direction of the target vehicle (G) and the moving direction of the reference vehicle (E) are the same direction as each other. The ECU 130 can calculate the relative speed (VF′) of the target vehicle (G) on the basis of Equations 5 and 6.

Next, similarly with the aforementioned, the angle (θ12) for the position of the target vehicle (G) based on the moving direction (D1) of the reference vehicle (E) can be calculated on the basis of the speeds (VX0′ and VY0′), and can be also calculated on the basis of the distances (L11 and L12 in FIG. 9).

When the angle (θ12) is calculated on the basis of the speeds (VX0′ and VY0′), it can be expressed as in Equation 7 below.

$$θ 12 = {tan}^{- 1} \frac{V X {0}^{′}}{V Y {0}^{′}} \qquad ( 7 )$$

Also, when the angle (θ12) is calculated on the basis of the distances (L11 and L12), it can be expressed as in Equation 8 below.

$$θ 12 = {tan}^{- 1} \frac{L 12}{L 11} \qquad ( 8 )$$

As aforementioned, the headlamp control devices 100 and 101 for the vehicle recognize a time when a target vehicle enters within a set distance and set angle range of the vehicle front by the front sensor 120 such as a radar sensor, a ridar sensor, or a camera and automatically adjust a headlamp from high beams to low beams and therefore, can reduce opponent driver's eye dazzling. Also, if the target vehicle does not enter within the set distance and set angle range of the vehicle front, the headlamp control devices 100 and 101 for the vehicle keep the headlamp in a high-beams state and therefore, can sufficiently guarantee a driver's visibility range.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A headlamp control device for a vehicle, the device comprising:
a front sensor for sensing a target vehicle existing within a set area of the front of a reference vehicle, and outputting a sense signal;
a wheel speed sensor installed in a wheel of the reference vehicle, and detecting a speed of the reference vehicle on the basis of a rotatory speed of the wheel;
an Electrical Control Unit (ECU) for outputting a switching control signal in response to a lighting signal and, while first and second high-beam lamps light on, calculating a relative speed of the target vehicle, a distance between the reference vehicle and the target vehicle, and an angle for a position of the target vehicle based on a moving direction of the reference vehicle, on the basis of the speed of the reference vehicle received from the wheel speed sensor and the sense signal received from the front sensor and, on the basis of the calculation result, outputting a control current;
a first ballaster for generating a first boosting voltage on the basis of an internal voltage, and supplying the first booting voltage as an operation power source to a first High Intensity Discharge (HID) lamp;
a second ballaster for generating a second boosting voltage on the basis of the internal voltage, and supplying the second boosting voltage as an operation power source to a second HID lamp;
a relay switch for, when the internal voltage is applied, supplying the internal voltage to the first and second high-beam lamps and, while the control current is supplied by the ECU, stopping supplying the internal voltage to the first and second high-beam lamps and then, supplying the internal voltage to the first and second ballasters; and
a power supply switch turning on in response to the switching control signal, and applying the internal voltage to the relay switch.

2. The device of claim 1, wherein, when the distance between the reference vehicle and the target vehicle is comprised within a set distance range, and the angle for the position of the target vehicle based on the moving direction of the reference vehicle is comprised within a set angle range, the ECU supplies the control current to the relay switch and, when the distance between the reference vehicle and the target vehicle is out of the set distance range, or the angle for the position of the target vehicle based on the moving direction of the reference vehicle is out of the set angle range, stopping supplying the control current.

3. The device of claim 2, wherein the set angle range is up to 120° at each of a left side and right side of the moving direction of the reference vehicle, on the basis of the moving direction of the reference vehicle.

4. The device of claim 1, wherein the sense signal is a reflection radar signal,
wherein the front sensor comprises one or two radar sensors installed in a front part of the reference vehicle, and
wherein the one or two radar sensors each comprise:
a transmit antenna for transmitting a radar signal within a set area of the reference vehicle front at a set time interval; and
a plurality of receive antennas for receiving the reflection radar signal that is a reflection and return of the radar signal transmitted by the transmit antenna from the target vehicle, and outputting the received reflection radar signal to the ECU.

5. The device of claim 1, wherein the sense signal is a reflection infrared signal,
wherein the front sensor comprises one or two ridar sensors installed in a front part of the reference vehicle, and
wherein the one or two ridar sensors each comprise:
an infrared transmit diode for generating an infrared signal;
a rotatory mirror rotated at a set speed by a motor, and controlling a transmit direction of the infrared signal such that the infrared signal scans a set area of the reference vehicle front; and
a photo diode receiver for receiving the reflection infrared signal that is a reflection and return of the infrared signal from the target vehicle, and outputting the received reflection infrared signal to the ECU.

6. The device of claim 1, further comprising, a steering wheel angle sensor for detecting a rotatory angle of a steering wheel of the reference vehicle,
wherein the sense signal is a photograph data signal,
wherein the front sensor comprises one or two cameras installed in a front part of the reference vehicle, taking photograph of the set area of the reference vehicle front, and outputting the photograph data signal to the ECU, and
wherein, while the first and second high-beam lamps light on, the ECU calculates the relative speed of the target vehicle, the distance between the reference vehicle and the target vehicle, and the angle for the position of the target vehicle based on the moving direction of the reference vehicle, on the basis of the speed of the reference vehicle received from the wheel speed sensor, the rotatory angle of the steering wheel received from the steering wheel angle sensor, and the photographed data signal received from the one or two cameras.
